(19) United States
(12) Patent Application Publication
(10) Pub. No.: US 2025/0351847 A1
(43) Pub. Date: Nov. 20, 2025

(54) Pet Food Flavor Enhancement Processing Method

(71) Applicant: TAN GROW INC., BLUE ISLAND, IL (US)

(72) Inventor: Mengmeng MU, Ningbo (CN)

(21) Appl. No.: 19/280,119

(22) Filed: Jul. 25, 2025

Related U.S. Application Data
(63) Continuation of application No. PCT/CN2025/073913, filed on Jan. 22, 2025.

(30) Foreign Application Priority Data
Jan. 23, 2024 (CN) 202410095353.8
Jan. 22, 2025 (WO) PCT/CN2025/073913

(51) Int. Cl. A23K 40/30; A23K 50/40

(52) U.S. Cl. CPC A23K 40/30; A23K 50/40

(57) ABSTRACT

A flavor enhancement processing method for pet food includes the steps of: preparing a flavor-enhancing material; bringing the flavor-enhancing material into contact with the surface of the pet food raw material to form a flavor enhancement layer; and curing the flavor enhancement layer so that it adheres to the surface of the pet food, thereby obtaining a processed pet food product. This flavor enhancement processing method can significantly improve the taste and flavor of the pet food, better satisfying the pet's palate preferences and increasing its appetite, particularly benefiting pets that are picky eaters or have a poor appetite. Moreover, the involvement of the pet owner in the preparation process enhances the enjoyment of pet keeping.

### CROSS REFERENCE OF RELATED APPLICATION

This is a Continuation Application of PCT/CN2025/073913, filed Jan. 22, 2025, which claims priority under 35 U.S.C. 119(a-d) to Chinese application numbers 202410095353.8, filed Jan. 23, 2024, wherein the entire content of which is expressly incorporated herein by reference.

### BACKGROUND OF THE PRESENT INVENTION

### Field of Invention

The present invention relates to field of pet food processing, and more particular to a pet food flavor enhancement processing method.

### Description of Related Arts

In recent years, more and more people have been keeping pets, and the increase in people's disposable income has helped them increase their spending on pet food, pet supplies, and pet services. The trend of pet-friendly pets will further encourage owners to buy better products for their pets, such as the most basic staple food, pet snacks, and pet health products.

With the development of the pet economy, pet owners and pets have higher and higher requirements for the quality and taste of pet food. Pet owners pay more attention to the nutrition and taste of pet food, and the taste of pet food directly affects the appetite and health of pets. When processing traditional pet food, some rely on the flavor of the raw materials themselves or add flavor powder to season. Some are pressed and molded by mixing multiple raw materials, but these pet foods often have a single taste in taste and cannot meet the needs of some pets, especially picky pets. If the pet food bought back is not liked by the pet, it will cause waste. And the owner is not interactive during the feeding process with the pet. Therefore, it is particularly important to develop a flavoring processing method that can improve the taste of pet food and increase the fun of the owner feeding the pet.

### SUMMARY OF THE PRESENT INVENTION

An advantage of the present invention is that it provides a pet food flavoring processing method which can significantly improve the taste and flavor of pet food, better meet the taste needs of pets, and involve the owner in the process of preparing pet food, thereby increasing the fun of pet raising.

Another advantage of the present invention is that it provides a method for processing pet food flavor enhancement, which can stimulate the pet's sense of smell and taste by attaching a flavor enhancement layer on the surface of the pet food, making the pet food more attractive, thereby increasing the pet's appetite, especially having a positive effect on those pets who are picky eaters or have poor appetite.

Another advantage of the present invention is that it provides a pet food flavoring processing method which can increase the nutritional content of the pet food by adding a flavor enhancement layer outside the pet food.

Another advantage of the present invention is that it provides a pet food flavoring processing method, wherein in the pet food product produced by the pet food flavoring processing method, the flavor enhancement layer can be designed with a variety of flavors according to the taste preferences of different pets, such as meat flavor, fish flavor, vegetable flavor, etc., to meet the personalized needs of different pets.

Another advantage of the present invention is that it provides a pet food flavoring processing method, wherein in the pet food product produced by the pet food flavoring processing method, the addition of the flavor enhancement layer not only increases the flavor, but also improves the taste of the pet food, making it crispy or soft and tender, and can be adjusted according to the preferences of different pets.

Another advantage of the present invention is that it provides a pet food flavoring processing method, wherein the pet owner adjusts the ingredients of the flavor enhancement layer based on the pet's feedback, thereby finding the taste that his or her pet likes, increasing the pet owner's satisfaction, cultivating the pet owner's sense of responsibility and love, and enhancing the relationship between the pet and the owner.

Another advantage of the present invention is that it provides a pet food flavoring processing method, and a processing equipment provided is suitable for use at home or in a pet management center.

According to an aspect of the present invention, the present invention provides a pet food flavoring processing method which comprises the following step:
(a) applying a flavoring material which is in contact with a surface of a pet food raw material to form a flavor enhancement layer on the surface of the pet food raw material.

According to one embodiment, before the step (a), the flavoring material is manufactured from a flavoring raw material, and the flavoring material is liquid, slurry, solid or gas.

According to one embodiment, in the step (a), the flavoring raw material is selected from meat, vegetable, fruit or dairy product.

According to one embodiment, in the step (a), the flavoring raw material is formed by pulping with water, squeezing with water, or cutting and grinding.

According to one embodiment, in the step (a), the surface of the pet food raw material is coated to form the flavor enhancement layer by at least one of spraying, soaking, brushing, vibration and liquid stirring.

According to one embodiment, the method further comprises a step of:
solidifying the flavor enhancement layer on the surface of the pet food raw material.

According to one embodiment, the flavor enhancing layer is matured and fixed on the surface of the pet food raw material by drying.

According to one embodiment, the flavor enhancement layer has a thickness of 0.1 to 5.0 mm.

According to one embodiment, the surface of the pet food raw material is evenly coated with the flavor enhancing layer.

According to one embodiment, the steps of preparing the flavoring material, coating the flavor enhancement layer, and solidifying the flavor enhancement layer are automatically completed in a pet food flavoring processing device.

Further objects and advantages of the present invention will be fully apparent from an understanding of the following description and the accompanying drawings.

### BRIEF DESCRIPTION OF THE DRAWINGS

FIG. 1 is a cross-sectional view of a pet food raw material in a pet food flavoring processing method according to a preferred embodiment of the present invention.

FIG. 2 is a cross-sectional view of a pet food processed food according to the pet food flavoring processing method according to the preferred embodiment of the present invention.

FIG. 3 is a block diagram of a pet food flavoring processing method according to the preferred embodiment of the present invention.

### DETAILED DESCRIPTION OF THE PREFERRED EMBODIMENT

The following description is used to disclose the present invention so that those skilled in the art can implement the present invention. The preferred embodiments described below are only examples, and those skilled in the art can think of other obvious variations. The basic principles of the present invention defined in the following description can be applied to other embodiments, variations, improvements, equivalents, and other technical solutions that do not deviate from the spirit and scope of the present invention.

Those skilled in the art should understand that, in the disclosure of the present invention, the terms “longitudinal”, “lateral”, “up”, “down”, “front”, “back”, “left”, “right”, “vertical”, “horizontal”, “top”, “bottom”, “inside”, “outside” and the like indicating the orientation or position relationship are based on the orientation or position relationship shown in the drawings, which are only for the convenience of describing the present invention and simplifying the description, rather than indicating or implying that the device or element referred to must have a specific orientation, be constructed and operated in a specific orientation. Therefore, the above terms should not be understood as limiting the present invention.

It is to be understood that the term “a” or “an” should be understood as “at least one” or “one or more”, that is, in one embodiment, the number of an element may be one, while in another embodiment, the number of the element may be multiple, and the term “a” or “an” should not be understood as a limitation on the quantity.

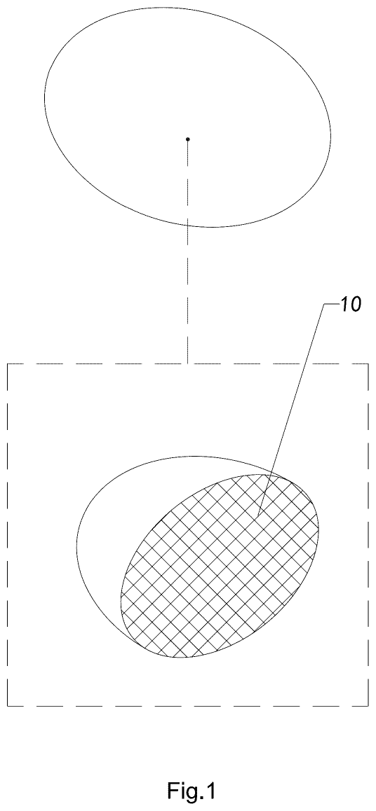

Referring to FIGS. 1 to 3, a pet food flavoring processing method according to a preferred embodiment of the present invention is illustrated. The pet food flavoring processing method is used for pet owners to prepare pet food processed food 1 by themselves. The pet food processed food 1 has a better taste and flavor, can better meet the taste needs of pets, can stimulate the pet's sense of smell and taste, thereby increasing the pet's appetite, especially for those picky eaters or those with poor appetite. In addition, the pet owner participates in the preparation of the pet food processed food 1. The pet owner adjusts the taste of the pet food processed food 1 according to the pet's feedback, thereby enriching the pet's diet while increasing the pet owner's fun and sense of accomplishment, so that the relationship between the pet and the owner can be further enhanced.

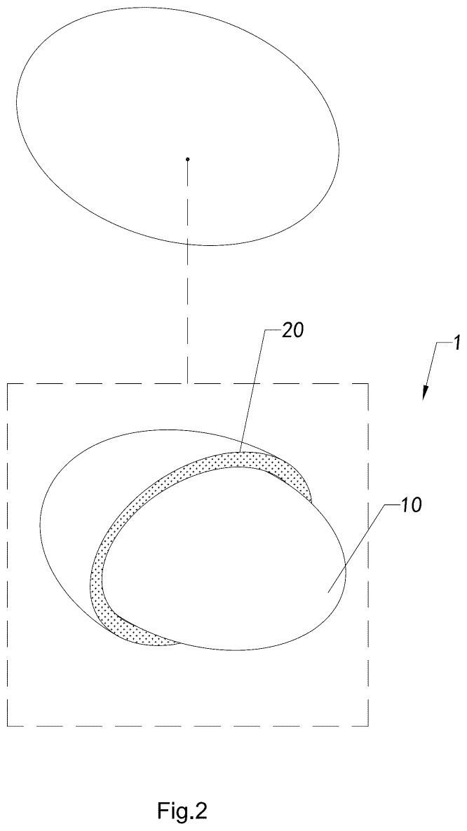

FIG. 1 is a cross-sectional view of a pet food according to a pet food flavoring processing method of the preferred embodiment of the present invention. FIG. 2 is a cross-sectional view of a pet food processed food 1 according to the pet food flavoring processing method of the preferred embodiment of the present invention. As shown in FIGS. 1 and 2, the pet food processed food 1 comprises a pet food raw material 10 and a flavor enhancement layer 20, wherein the flavor enhancement layer 20 is attached to the outside of the pet food raw material 10, and preferably, the flavor enhancement layer 20 is uniformly wrapped around the outside of the pet food raw material 10.

In particular, in the embodiment of the present application, the material of the pet food raw material 10 is not limited by the present application. The pet food raw material 10 can be implemented as traditional cat food or dog food available on the market. A person of ordinary skill in the art should know that based on the different types and individuals of pets, they have different preferences for the pet food raw materials 10 of different materials. In this regard, the pet owner can select a suitable pet food raw material 10 to prepare the pet food processed food 1.

The pet food raw material 10 can be puffed food, baked food, air-dried food, freeze- dried food, etc. according to its preparation process. Puffed food is made by grinding the raw material into powder and then putting it into the puffing machine for extrusion molding through high-temperature puffing process. Fresh meat is not added in the process, but meat powder and starch are generally added to facilitate molding. Finally, oil and some nutrients are sprayed to ensure the nutritional needs of pets.

To bake grains, the raw materials are first crushed, then pressed into shape under low temperature and low pressure, and then slowly baked. The baking process is not affected by high temperature, starch is generally not added, and the nutrients of the raw materials are basically not lost.

Air-dried food is made by air-drying food in a simulated natural environment. The raw materials are sliced and then air-dried at a certain temperature. It is basically made of fresh meat, and the temperature is not too high, so the nutrients in the ingredients themselves will basically not be lost. Generally, air-dried food is made by air-drying fresh meat to increase palatability.

Freeze-dried food is made by freezing and vacuum drying the raw materials at low temperature. Freeze-drying is generally divided into three main processes: pre-freezing, sublimation drying, and analytical drying. Sublimation and analytical drying are carried out under vacuum conditions, and freeze-drying is carried out at low temperatures and in a high vacuum state. Therefore, it is particularly suitable for many heat-sensitive substances, such as proteins, aromatic amino acids that constitute the natural flavor of meat, vitamins, etc., which will not be denatured or lose biological activity. Some easily oxidized substances are protected, retaining the color, aroma, taste and nutritional components of fresh food.

The raw materials of the pet food raw materials 10 may include but are not limited

to pet food produced by brand manufacturers such as Royal, Purina, Pedigree, ProNer, Birridge, Myfood, Crave, Whiskas, and Soligo. The forms of the pet food raw materials 10 include but are not limited to flakes, blocks, strips, balls, etc., and their shapes include but are not limited to round, square, triangle, hexagon, plum blossom, etc.

In particular, in the embodiment of the present application, in order to solve the problem that traditional pet food often cannot meet the needs of some pets in terms of taste, the pet food processed food 1 in the embodiment of the present application adopts an optimized processing method suitable for pet owners or managers of pet management centers to prepare pet food with enhanced taste, rich taste and nutrition based on the pet food raw materials 10.

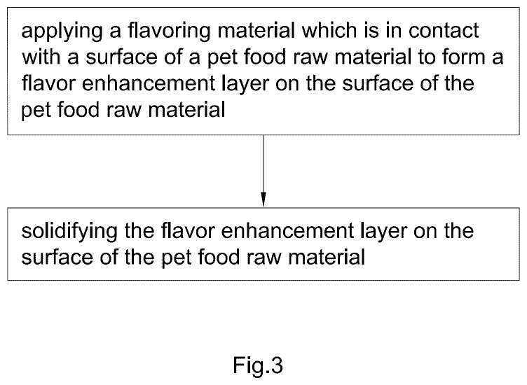

FIG. 3 is a block diagram of the pet food flavoring processing method according to the preferred embodiment of the present invention. In this embodiment, the pet food flavoring processing method includes: preparing a flavoring material; contacting the flavoring material with the surface of the pet food raw material 10 to form the flavor enhancement layer 20; and curing the flavor enhancement layer 20 to make it adhere to the surface of the pet food to obtain the pet food processed food 1.

In the step of preparing the flavoring material, more specifically, the flavor enhancement layer 20 is formed by forming a flavoring material on the surface of the pet food raw material 10 and curing it. The flavoring material can be implemented as liquid, slurry, solid or gas.

In the process of preparing the flavoring material, the method of preparing the flavoring material comprises but is not limited to forming the flavoring material by crushing the flavoring raw material and adding water to pulp; forming the flavoring material by crushing the flavoring raw material and adding water to squeeze out the juice; forming the flavoring material by cutting and grinding the flavoring raw material to make it into powder or forming the flavoring material by collecting the smell of the flavoring raw material, for example, when the flavoring raw material is meat, forming the flavoring material by collecting the meat aroma.

Flavoring raw materials may comprise but is not limited to meat, vegetables, fruits or dairy products. Preferably, the tendons of meat or the stems and roots of vegetables need to be removed to facilitate the pulping of the raw materials. In a possible implementation of the blending and pulping method, the meat is first cleaned and cut into small pieces, minced by a meat grinder configured in the processing equipment of the present invention, and after adding an appropriate amount of clean water, stirred evenly by a stirring device to form meat pulp.

It is understood that meat comprises but is not limited to pork, beef, mutton, chicken, duck, goose, fish, shrimp, crab, shellfish, etc. Vegetables comprise but are not limited to pumpkin, potato, sweet potato, etc. Green leafy vegetables can be blended into juice and added to the meat paste to increase the flavor. Fruits comprise but are not limited to apples, oranges, bananas, etc. Dairy products comprise but are not limited to milk powder, milk, cheese, condensed milk, etc.

Based on this, the pet food flavoring processing method can increase the nutritional components of the pet food processed food 1, such as protein, fat, minerals, vitamins, etc., by adding the flavor enhancement layer 20 outside the pet food raw material 10. In addition, the addition of the flavor enhancement layer 20 not only increases the flavor, but also improves the taste of the pet food processed food 1, making it crispier or softer, and can be adjusted according to the preferences of different pets.

It is worth mentioning that when the material of the flavoring raw material is meat, the viscosity of the flavoring material formed by crushing and pulping is relatively high, which is conducive to the coating of the flavoring material on the surface of the pet food raw material 10, so that the flavoring material can be evenly wrapped on the outside of the pet food raw material 10. When the material of the flavoring raw material is vegetables, the viscosity of the flavoring material formed by crushing and pulping is relatively low. In the process of preparing the flavoring material and the pet food raw material 10, food-grade gelatin, starch, lecithin or a combination thereof can also be added to help viscosity. The viscosity of the flavoring material is increased, which is conducive to the even wrapping of the flavoring material on the outside of the pet food raw material 10. In addition, the viscosity of the flavoring material can also be increased by mixing the flavoring raw materials of meat and vegetables.

Next, the flavoring material is used to form the flavor enhancement layer 20 on the surface of the pet food raw material 10. Here, the flavor enhancement layer 20 may be formed by, but is not limited to, spraying, soaking, brushing, stirring, vibrating or rolling.

For example, in a possible implementation, the flavor enhancement layer 20 can be applied to the pet food raw material 10 by soaking. Specifically, the pet food raw material 10 is placed in a hollow mold, and the pet food raw material 10 and the hollow mold are immersed in a container storing the flavoring material. After soaking for a predetermined time, the pet food raw material 10 and the hollow mold are taken out. At this time, the flavoring material is evenly wrapped on the outside of the pet food raw material 10. Finally, the excess flavoring material is collected and put back into the container, and the step of coating the flavoring material on the surface of the pet food raw material 10 to form the flavor enhancement layer 20 can be completed. The soaking coating method is suitable for pet food raw materials 10 of various shapes. For example, for the bone-shaped pet food raw material 10 required by pet dogs, the flavor enhancement layer 20 can be evenly coated on the pet food raw material 10 by soaking. When the flavoring material is a liquid or a slurry, the flavor enhancement layer 20 can be applied to the pet food raw material 10 by soaking.

For another example, in another possible implementation, the flavor enhancement layer 20 can be applied to the pet food raw material 10 by spraying. Specifically, the pet food raw materials 10 are neatly arranged in the positioning holes of a positioning mold, the flavoring material is poured into a spray gun, and the flavoring material is evenly sprayed onto the outer surface of the pet food raw material 10 by the spray gun to form the flavor enhancement layer 20. It is worth mentioning that when the flavoring material is a gas, liquid or slurry, the flavor enhancement layer 20 can be applied to the pet food raw material 10 by spraying.

In another possible implementation, the flavor enhancement layer 20 can be applied to the pet food raw material 10 by brushing. Specifically, the pet food raw materials 10 are neatly arranged in the positioning holes of the positioning mold, and the flavoring material is evenly brushed onto the outer surface of the pet food raw material 10 by a brush to form the flavor enhancement layer 20. When the flavoring material is a liquid or slurry, the flavor enhancement layer 20 can be applied to the pet food raw material 10 by brushing. The spraying and brushing coating methods are applicable to the pet food raw materials 10 of various shapes, such as round, square or long strips.

For another example, in another possible implementation, the flavor enhancement layer 20 can be applied to the pet food raw material 10 by rolling. Specifically, the pet food raw material 10 is placed in a rolling device, and the flavoring material is uniformly poured into the rolling device. By rolling in the rolling device, the flavoring material is uniformly rolled and adsorbed onto the outer surface of the pet food raw material 10 to form the flavor enhancement layer 20. The rolling coating method has a high degree of automation and is convenient for pet owners to operate. When the flavoring material is solid, liquid or slurry, the flavor enhancement layer 20 can be applied to the pet food raw material 10 by rolling.

In addition, in the step of drying and curing the flavor enhancement layer 20 so that the flavor enhancement layer 20 adheres to the surface of the pet food raw material 10, the pet food processed food 1 is obtained. Here, the drying and curing treatment can be carried out by using an oven or other device to perform drying and curing treatment, so that the flavor enhancement layer 20 is further matured and firmly fixed on the surface of the pet food raw material 10. In this regard, those skilled in the art should understand that the drying and curing treatment of the flavor enhancement layer 20 is not a limitation of the present invention.

In the embodiment of the present application, the temperature of the drying and

curing treatment of the flavor enhancement layer 20 is set to 50° C. to 80° C., and the duration is 10 to 30 minutes. It is ensured that the flavor enhancement layer 20 can be evenly fixed on the outside of the pet food raw material 10. By selecting the appropriate temperature and time for the drying and curing treatment, the loss of nutrients and water in the processed pet food 1 can be avoided, and the processed pet food 1 can be ensured to have the best flavor, improve the taste of the pet food, and make it more crispy or tender.

In addition, in the embodiment of the present application, preferably, the thickness of the flavor enhancement layer 20 is 0.1 to 5 mm. The flavor enhancement layer 20 of suitable size makes the overall size of the processed pet food 1 meet the actual needs. The appropriate ratio of the flavor enhancement layer 20 and the pet food raw material 10 can be ensured, thereby ensuring that the pet takes in balanced nutrition. On the other hand, the appropriate thickness of the flavor enhancement layer 20 helps to control the production cost, which can meet the taste requirements of the pet without increasing unnecessary costs due to excessive seasonings.

In summary, the pet food processed food 1 produced by the pet food flavoring processing method has a better taste and flavor than the traditional pet food raw material 10, can better meet the taste needs of pets, can stimulate the pet's sense of smell and taste, thereby increasing the pet's appetite, especially for those picky eaters or those with poor appetite. At the same time, by adding the flavor enhancement layer 20 to the pet food raw material 10, the nutritional content of the pet food processed food 1 can be increased, making the pet healthier.

Accordingly, according to one embodiment, the present invention provides a pet food flavoring processing device for pet owners to coat the purchased pet food raw materials 10 with a new flavor layer according to the preferences of their pets, comprising a mincing device, a hollow mold, a soaking device, and a curing device, wherein the mincing device minces meat or vegetables and makes the flavoring material in a slurry state after adding water, the hollow mold is used to accommodate the pet food raw materials 10, the soaking device is used to coat the pet food raw materials 10 in the hollow mold with the flavoring material, and the curing device can dry and solidify the flavoring material coated on the pet food raw materials 10 to finally form the pet food processed food 1.

According to one embodiment, the present invention provides a pet food flavoring processing equipment for pet owners to coat a new flavor layer on the basis of the purchased pet food raw material 10 according to the pet's preferences, comprising a mincing device, a positioning device, a spray gun, and a curing device, wherein the mincing device minces meat or vegetables and makes the flavoring material into a slurry after adding water, the positioning device is used to accommodate and position the pet food raw material 10, the spray gun is used to spray the pet food raw material 10 in the positioning mold with the flavoring material, and the curing device can dry and solidify the flavoring material coated on the pet food raw material 10 to finally form the pet food processed food 1.

According to one embodiment, the present invention provides a pet food flavoring processing equipment for pet owners to coat the purchased pet food raw materials 10 with a new flavor layer according to the preferences of their pets, comprising a mincing device, a positioning device, a brushing device, and a curing device, wherein the mincing device minces meat or vegetables and makes the flavoring material in a slurry after adding water, the positioning device is used to accommodate and position the pet food raw materials 10, the brushing device is used to brush the flavoring material on the pet food raw materials 10 in the positioning mold, and the curing device can dry and solidify the flavoring material coated on the pet food raw materials 10 to finally form the pet food processed food 1.

According to one embodiment, the present invention provides a pet food flavoring processing equipment for pet owners to coat a new flavor layer on the basis of the purchased pet food raw material 10 according to the pet's preferences, comprising a mincing device, a rolling stirring device, and a curing device, wherein the mincing device minces meat or vegetables and makes the flavoring material into a slurry after adding water, the rolling stirring device is used to accommodate the pet food raw material 10, and the flavoring material is added to the rolling stirring device, the rolling stirring device drives the pet food raw material 10 to roll in its inner cavity so that it is evenly coated with the flavoring material, and the curing device can dry and solidify the flavoring material coated on the pet food raw material 10 to finally form the pet food processed food 1.

It can be understood that the pet food flavoring processing equipment in the above embodiments can form a set of kits or be integrated into the same machine. In this way, the pet owner only needs to select the appropriate ingredients, and the subsequent processing process can be completed automatically by the machine, which is convenient for the pet owner to operate.

It should be understood by those skilled in the art that the embodiments of the present invention described above and shown in the accompanying drawings are only examples and do not limit the present invention. The purpose of the present invention has been fully and effectively achieved. The functional and structural principles of the present invention have been demonstrated and explained in the embodiments, and the embodiments of the present invention may be deformed or modified in any way without departing from the principles.

What is claimed is:

1. A pet food flavoring processing method, comprising the following step:
(a) applying a flavoring material which is in contact with a surface of a pet food raw material to form a flavor enhancement layer on the surface of the pet food raw material.

2. The pet food flavoring processing method according to claim 1, wherein before the step (a), the flavoring material is manufactured from a flavoring raw material, and the flavoring material is one of liquid, slurry, solid and gas.

3. The pet food flavoring processing method according to claim 2, wherein in the step (a), the flavoring raw material is selected from the group consisting of meat, vegetable, fruit and dairy product.

4. The pet food flavoring processing method according to claim 3, wherein in the step (a), the flavoring raw material is formed by pulping with water, squeezing with water, or cutting and grinding.

5. The pet food flavoring processing method according to claim 1, wherein in the step (a), the surface of the pet food raw material is coated to form the flavor enhancement layer by at least one of spraying, soaking, brushing, vibration and liquid stirring.

6. The pet food flavoring processing method according to claim 5, further comprising a step of solidifying the flavor enhancement layer on the surface of the pet food raw material.

7. The pet food flavoring processing method according to claim 6, wherein the flavor enhancing layer is matured and fixed on the surface of the pet food raw material by drying.

8. The pet food flavoring processing method according to claim 6, wherein the flavor enhancement layer has a thickness of 0.1 to 5.0 mm.

9. The pet food flavoring processing method according to claim 5, wherein the surface of the pet food raw material is evenly coated with the flavor enhancing layer.

10. The pet food flavoring processing method according to claim 6, wherein the steps of preparing the flavoring material, coating the flavor enhancement layer, and solidifying the flavor enhancement layer are automatically completed in a pet food flavoring processing device.
